(19) United States
(12) Patent Application Publication
(10) Pub. No.: US 2005/0173631 A1
(43) Pub. Date: Aug. 11, 2005

(54) Determining end points during charged particle beam processing

(76) Inventors: Valery Ray, Haverhill, MA (US); Larry Scipioni, Danvers, MA (US); Neil J. Bassom, Hamilton, MA (US)

Correspondence Address: MICHAEL O. SCHEINBERG, P.O. BOX 164140, AUSTIN, TX, 78716-4140, US

(21) Appl. No.: 10/777,672

(22) Filed: Feb. 11, 2004

(51) Int. Cl. G01N 23/225

(52) U.S. Cl. 250/307; 250/310; 250/309

(57) ABSTRACT

The invention increases the sensitivity of end point detection in charged particle beam processing by using the blanking frequency of the charged particle beam as a reference frequency. The modulating frequency of the charged particle beam can be readily detected in a detected signal by using the reference frequency in a frequency sensitive circuit, such as a lock in amplifier. A change in the modulating frequency in the detected signal indicates that the beam is impinging on a change in the material in the work piece, so an operation to mill through an insulating layer to expose the conductor, or operation to mill through a conductor, is halted.

### TECHNICAL FIELD OF THE INVENTION

The present invention relates to the field of charged particle beam processing and, in particular, to detecting changes in a work piece during such processing.

### BACKGROUND OF THE INVENTION

Semiconductor devices such as microprocessors can be made up of millions of transistors, each interconnected by thin metallic lines branching over several levels and electrically isolated from each other by layers of dielectric materials. When a new semiconductor design is first produced in a semiconductor fabrication facility, it is typical to find that the design does not operate exactly as expected. It is then necessary for the engineers who designed the device to review their design and “rewire” it to achieve the desired functionality. Due to the complexity of building a semiconductor device in the semiconductor fabrication facility, it typically takes weeks or months to have the re-designed device produced. Further, the changes implemented frequently do not solve the problem, or the changes expose another difficulty in the design. The process of testing, re-designing and re-fabrication can significantly lengthen the time to market new semiconductor devices.

Circuit editing—the process of modifying a circuit during its development without having to remanufacture the whole circuit—provides tremendous economic benefits by reducing both processing costs and development cycle times. In most cases, the feature to be modified is buried under other material, such as insulating layers or, in the case of “flip chips,” semiconductor layers. It is typically necessary to mill down through these layers of materials to reach the feature of interest, while avoiding damage to adjacent circuit features. Once the buried feature is exposed, circuit editing typically entails either breaking an electrical connection by cutting a conductor or creating a new electrical connection by depositing new conducting pathways. New electrical pathways can be formed, for example, by charged particle beam induced deposition or a laser beam induced deposition, in which processes precursor materials are decomposed in the presence of the beam to form the desired conductor pattern.

Milling through a conductor can be accomplished, for example, using charged particle beam processing, laser ablation, such as with a pulsed, pico-second laser, or chemical assisted optical beam etching. Charged particle beam systems and laser system for etching and depositing are commercially available, for example, from FEI Company, the assignee of the present invention. Charged particle beam processing includes, for example, focused ion beam (FIB) sputtering, chemical assisted FIB etching, and electron beam assisted chemical etching. The term “mill” as used herein is used very generally to cover any process that removes material from a work piece, including etching and sputtering. Charged particle beam milling is typically performed by scanning the beam in a raster or serpentine pattern from the top to the bottom of a rectangular area, often referred to as a “box.” When the beam reaches the bottom of the rectangular area, the beam is “blanked,” that is, it is directed into an off-axis element to prevent the beam from reaching the work piece. While the beam is blanked, the beam positioning devices are adjusted so that the beam will be repositioned back to the top corner of the rectangle when it is unblanked. A rectangular pattern is typically scanned at a rate of 100 to 500 times per second.

When the charged particles in the beam hit the work piece surface, secondary charged particles, that is, electrons, positive ions, and negative ions, are emitted. The secondary charged particles, along with backscattered particles, can be detected using any of several known detectors, such as a multichannel plate detector or an Everhart-Thomley detector, and are used to form an image, in which the brightness of the image at any point is related to the number of secondary particle, that is, the secondary particle current. The number and characteristics of the emitted secondary particles depends upon the work piece surface, and so a change in the current, which appears as a change in image contrast, can be used to detect a change in material under the beam.

The charged particles entering the work piece and the secondary charged particles leaving the work piece cause a charge imbalance, which in turn causes an electrical current, referred to as the “stage current,” between the stage holding the work piece and ground. Like the secondary particle current, the stage current will vary with the material under the beam because the stage current depends in part upon the secondary charged particles leaving the work piece.

One of the most difficult challenges in circuit editing is knowing when to stop milling. In the case of making additional connections, milling must continue until the conductor to be connected has been exposed so that contact can be made, but milling must stop before the exposed feature is damaged or cut through. If the milling is intended to sever a conductor, milling must stop before the layer under the conductor is damaged. The determination of the proper stopping or end point is referred to as “endpointing.”

Some endpointing techniques determine when a new layer has been exposed by detecting a change in secondary particle current, which causes a change in contrast in the image. For example, when the beam has milled through an insulating region and starts to impinge on a conductive region, the brightness of that portion of the image will change markedly. The contrast between conductive and non-conductive materials in a charged particle beam image can be enhanced by applying a voltage to the conductive material. This technique is known as “voltage contrast” imaging, and one application of it is described, for example, in U.S. Pat. No. 5,140,164 to Talbot et al. for “IC Modification with Focused Ion Beam” (“Talbot”). Talbot applies a square wave having a frequency of about 1 Hz to a buried conductor. According to Talbot, the capacitance of the buried conductor causes the image to flash as the 1 Hz signal changes polarity. When the buried conductor is exposed, the capacitance coupling is gone and the quality of the image flashing changes, indicating to an observer that the processing is complete. Because Talbot relies on low frequencies, it is possible to inadvertently mill through a conductive layer before the observer notices the change. Talbot also requires making an electrical connection to the buried conductors, which can be disadvantageous.

U.S. Pat. No. 5,948,217 to Winer et al. for “Method and Apparatus for Endpointing While Milling an Integrated Circuit” (“Winer”) describes a method for determining an end point when milling near a semiconductor junction within a substrate. Winer teaches biasing a pn junctions in the substrate while milling, and detecting the end point of milling by observing a change in contrast when the beam crosses the electrically biased junction. Winer also teaches that crossing the pn junction by the ion beam could be determined by monitoring not only the secondary particle current, but also the stage current. Winer relies on applying a DC signal to, or adjacent to, the circuit element being edited.

Another method of determining when the material under the ion beam changes is by using a secondary ion mass spectrometer (SIMS) to determine the charge-to-mass ratio of the particles being emitted. From the charge to mass ratio, the type of particles can be inferred. A SIMS is relatively complex and expensive, and many focused ion beam systems do not include a SIMS.

All of the above endpointing methods depend upon secondary particles being emitted as the beam impacts the work piece. As modern integrated circuits use smaller and smaller conductors and multiple layers of those conductors separated by insulating layers, it is necessary that the holes milled by a focused ion beam to access buried conductors have a very small diameter to avoid damaging other conductors in intermediate layers. As the ratio of the hole depth to its diameter—referred to as the aspect ratio-, increases, the secondary particles ejected by the ion beam are increasingly blocked by the walls of the hole and do not reach the detector. As the width of the access hole shrinks and the depth becomes greater, the secondary particle signal becomes exceedingly small and can be lost in the noise of the system. This obscures the end point information.

Lundquist et al. in “Precise, In-Situ Endpoint Detection for Charged Particle Beam Processing,” U.S. Patent Application Pub. No. 2002/0074494 (A1) teaches detecting an end point using beam-induced leakage current (“BIC”) created in the integrated circuit as an ion beam produces conductive electron-hole pairs in the semiconductor material. The end point is determine by feeding the leakage current into a lock-in amplifier, which is referenced to a frequency at which the primary beam is pulsed or to the blanking frequency, to determine the end point. This method is therefore limited in that it is only useful for endpointing on transistors that have the junctions in which BIC can occur and requires electrical connections to the integrated circuit pins.

The ability to know when one has reached the feature of interest in creating an access hole (the endpointing process) is critical to performing circuit edit applications. The accuracy requirements for endpointing are getting tighter because the reduction in line thickness means there is less time to stop before the line is milled through. At the same time, the signal strength on which endpointing is typically based is decreasing due to both feature size reduction and the need for higher aspect ratio access holes. Thus, improved endpointing techniques are required for editing modern integrated circuits.

### SUMMARY OF THE INVENTION

It is an object of the invention, therefore, is to accurately detect changes in the work piece during charged particle beam processing.

In accordance with one aspect of the invention, a frequency sensitive circuit, such as a lock-in amplifier, is used to detect a change in a signal that indicates a change in the material impacted by the charged particle beam, with the blanking frequency used as the reference frequency for the frequency sensitive circuit. The secondary particle current or the stage current can be used as the input signal to the frequency sensitive circuit.

In another embodiment an alternating current signal is applied to a conductor in the substrate, and the alternating current is used as the reference signal for a frequency sensitive circuit, with the secondary particle signal or the stage current being used as the input to detect a change in the material being processed.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and the advantages thereof, reference is now made to the following descriptions taken in conjunction with the accompanying drawings, in which:

FIG. 1A is a cross sectional view showing a portion of a typical integrated circuit.

FIG. 1B is a cross sectional view showing a typical circuit edit performed on the integrated circuit of FIG. 1A.

FIG. 2A is a partial cross sectional view of a prior art integrated circuit showing the results of inaccurate end point detection using charged particle beam milling to expose a buried metal feature.

FIG. 2B is a partial cross sectional view of a prior art integrated circuit showing the results of inaccurate end point detection using charged particle beam milling to expose a buried metal feature.

FIG. 2C is a partial cross sectional view of a prior art integrated circuit showing the results of accurate end point detection using charged particle beam milling to expose a buried metal feature.

FIG. 3 is a flowchart showing the steps of a preferred embodiment of the present invention.

FIG. 4 is a flowchart showing the steps of another preferred embodiment of the present invention.

FIG. 5 shows a focused ion beam system suitable for implementing the present invention.

### DETAILED DESCRIPTION OF PREFERRED EMBODIMENTS

A preferred embodiment of the invention provides a system for detecting signals generated by impact of a charged particle beam on a work piece, which signals can provide an indication of when the material impacted by the beam changes, for example, when the beam has cut through a first material and entered a second material. Some embodiments of the invention do not require a signal to be applied to the circuit being edited, and so those techniques can be used in the absence of a conductor.

The invention is particularly useful for detecting weak signals, such as secondary electron or ion current or stage current generated when milling high aspect ratio holes, for example, in performing circuit edits or other charged particle beam machining. The increased sensitivity provided by the invention allows one to know more precisely when a hole being created has reached (or cleared through) a buried feature, such as a conductor, an insulating layer, or a semi-conductive layer.

Embodiments of the invention use a frequency sensitive circuit, that is, a circuit that can selectively detect, pass, or amplify a specific frequency, while eliminating noise at other frequencies, to improve the signal-to-noise (“S/N”) ratio of signals of a particular frequency. Such circuits can detect a weak signal of a particular frequency. In most such circuits, a reference signal of the same frequency and phase as that of the signal to be detected is input into the frequency sensitive circuit.

The frequency sensitive circuitry separates a frequency component of the secondary particle detector signal or stage current signal from the majority of the broadband noise. Thus the signal-to-noise ratio can be greatly enhanced and a change in the signal can be detected through noise that would otherwise obscure the change. A small change in the secondary particle current or the stage current can be sensitively detected, thereby indicating to an operator that the charged particle beam has entered a different type of material.

In some embodiments, the secondary electron or ion current or the stage current is detected and the blanking frequency of the primary beam of charged particles, electrons or ions, is used as the reference frequency. That is, rather than considering the signal from the secondary particles or the stage as a direct current signal that is interrupted during the blanking, the signal is treated as a periodic signal of the blanking frequency. In another embodiment, an AC signal is applied to a metal conductor in the work piece. The AC signal then which provides a periodic component to the secondary particle current or stage current.

The frequency sensitive circuit can be, for example, a band pass filter or a demodulator, which is one way of achieving band pass filtering. Lock-in amplifiers can be used to measure the amplitude and phase of signals buried in noise and are particularly well suited for use with the present invention. Lock-in amplifiers act as a narrow band pass filters, removing noise while passing and amplifying the modulated signal. The center of the pass band of the lock-in amplifier is set by a reference signal corresponding to, for example, the beam blanking frequency signal. The reference signal is phase-shifted as necessary to be in phase with the signal from the secondary particle detector or stage current. In the lock-in amplifier, the phase-shifted reference signal is combined with the secondary particle detector signal or stage current signal to produce a DC signal proportional to the modulated secondary particle detector signal. The DC signal is separated from the noise component using a low pass filter. Lock-in amplifiers are commercially available, for example, from EG&G Ortec, Oak Ridge, Tenn.

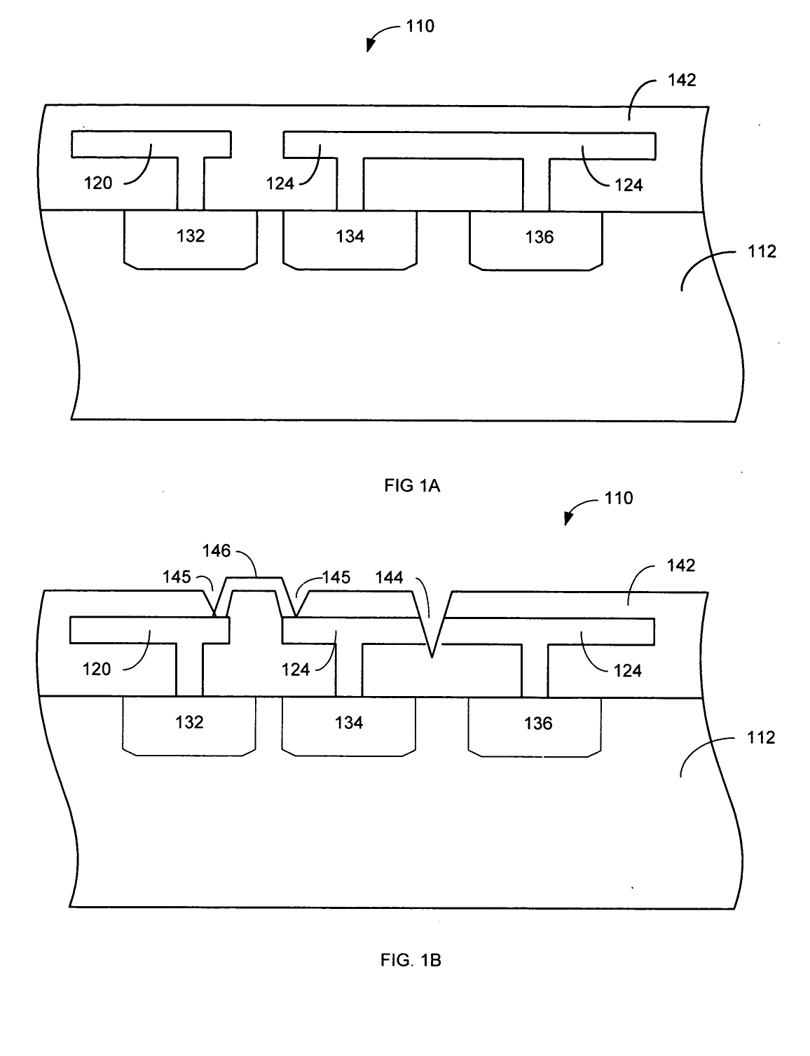

FIG. 1A is a cross sectional view showing schematically a portion of a typical integrated circuit 110. As shown in FIG. 1A, integrated circuit 110 includes substrate 112 and dielectric isolation layer 142. Metal interconnects 120 and 124 are coupled to diffusion regions 132, 134, and 136. Diffusion region 134 is coupled to diffusion region 136 through metal interconnect 124; and diffusion region 132 is not coupled to diffusion region 134.

FIG. 1B is a cross sectional view showing a circuit edit performed on an integrated circuit 110 of FIG. 1A. Integrated circuit 110 includes substrate 112 and dielectric isolation layer 142. Metal interconnects 120 and 124 are coupled to diffusion regions 132, 134 and 136. As shown in FIG. 1B, after circuit edits have been performed, diffusion region 134 is disconnected from diffusion region 136. Metal interconnect 124 has been physically cut by milling a hole 144 through the dielectric isolation layer 142. As shown in FIG. 1B, circuit edits have also been performed to connect diffusion region 132 to diffusion region 134. Hole 145 has been milled through dielectric isolation layer 142 to expose a portion of metal interconnect 122 and of metal interconnect 124. A conductor 146 has then been deposited to connect metal interconnect 122 to metal interconnect 124, thereby connecting diffusion region 132 to diffusion region 134.

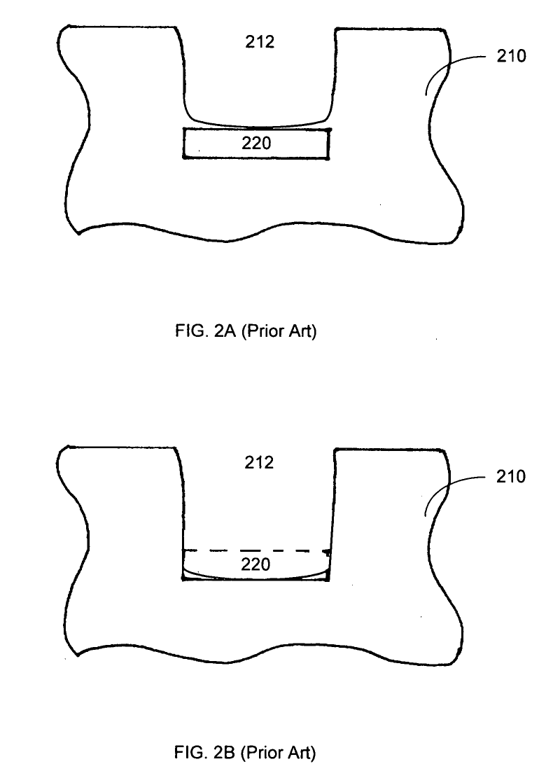

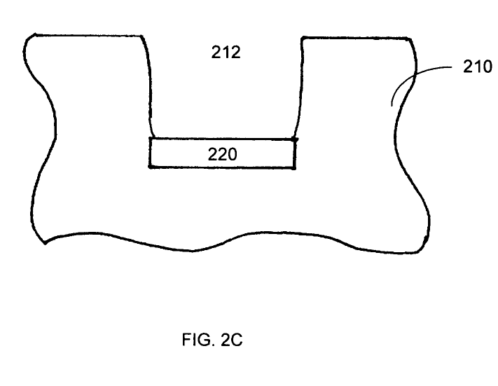

FIG. 2A and FIG. 2B are partial cross sectional views of a prior art integrated circuit showing the results of inaccurate end point detection using charged particle beam milling to expose a buried metal feature. In FIG. 2A and in FIG. 2B, a hole 212 has been milled in surface material 210 in an attempt to expose conductor 220. In FIG. 2A, the milling was halted too soon and a thin layer of surface material 210 still covers much of conductor 220. In FIG. 2B, hole 212 has been milled too deeply and conductor 220 has been partially severed.

FIG. 2C is a partial cross sectional view of a prior art integrated circuit showing the results of accurate end point detection using charged particle beam milling to expose a buried metal feature. In FIG. 2C, hole 212 has been accurately milled in surface material 210. Conductor 220 has been exposed, but not damaged.

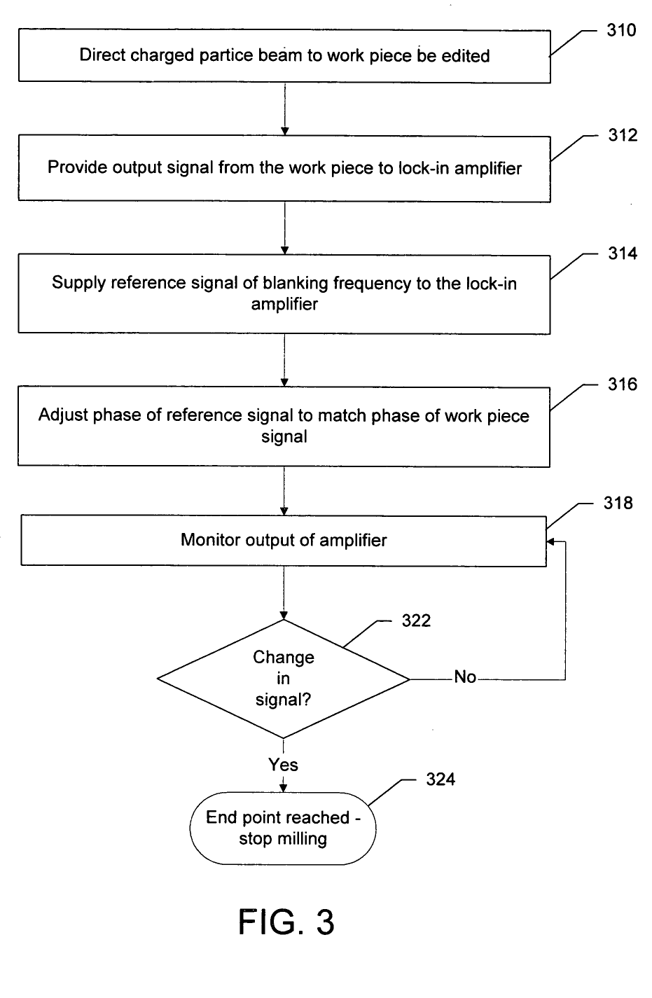

FIG. 3 is a flowchart showing the steps of a preferred embodiment of the present invention. To practice this invention, in step 310, the charged particle beam system is directed to the work piece to be modified. In step 312, an output signal from the work piece, such as a secondary electron or ion signal or a stage current, is provided to a frequency sensitive circuit, such as a lock-in amplifier. In step 314, a reference signal having the same frequency, and preferably derived from, the blanking signal of the ion beam raster process is supplied to a frequency sensitive circuit, such as a lock-in amplifier. In step 316, the phase of the reference signal is adjusted to provide to maximum amplifier output signal, that is, to be approximately in phase with the work piece output signal. This results in a direct current output from the lock-in amplifier, the output being proportional to the secondary particle signal.

In step 318, the output of the amplifier is monitored as milling continues. Minor changes in the output signal can indicate an end point. Step 322 comprises determining whether or not a change in the output signal is detected. If no change is detected, milling and monitoring continues. If a change is detected, an endpoint has been reached, and milling is stopped as shown in step 324.

When the secondary particle signal is used, it is not necessary to make electrical contacts to the work piece and, when using the blanking frequency as the reference signal, there is no need for additional modulating circuitry. Since this embodiment does not depend on applying a voltage to a conductive layer or biasing a junction within the integrated circuit, the method can be used to detect end points between non-conductive layers.

For typical box dimensions and milling parameters the blanking frequency is in the range 100-500 Hz and the beam is blanked for about half of each cycle. By using an integration time constant of 300 ms or so the amplifier can integrate the signal over up to several hundred mill cycles while averaging away the noise, thereby improving the S/N ratio. Changes in the secondary signal (i.e., the endpoint signal itself) will be detectable approximately 300 ms after they occur, which is satisfactory in most application to prevent overmilling. Skilled persons will recognize that the integration time can be varied depending the circumstances. Lengthening the integration time can increase the S/N ratio, but at the expense of taking more a longer time to detect a change and to cease milling. When the signal is stronger, the integration time can be reduced, thereby reducing the time required to detect a change and reducing over milling.

A second embodiment entails applying an alternating voltage to a conductive feature on the substrate and detecting the secondary particle or stage current, using the frequency of the applied alternating voltage as the reference signal for frequency sensitive circuit. This embodiment relies on the fact that a bias voltage applied to a conductive feature will change its secondary particle yield. For example, a positive bias will suppress secondary electron emission while a negative bias will enhance it, yielding weaker and stronger signals, respectively, for the detection system. This can be seen by the user as giving the metal feature a darker or brighter appearance in the image, be it an image created by using a FIB or by an electron beam, for example, in a scanning electron microscope.

Applying a modulating voltage to the conductive feature on the work piece will provide a modulated signal into the detection system. As such, the modulated detector signal can be separated out from the majority of the broadband noise by utilizing a frequency sensitive circuitry, such as a lock-in amplifier. Thus the signal-to-noise ratio can be greatly enhanced and a change in the detector signal can be detected through noise that would otherwise obscure the change in the unmodulated secondary particle current.

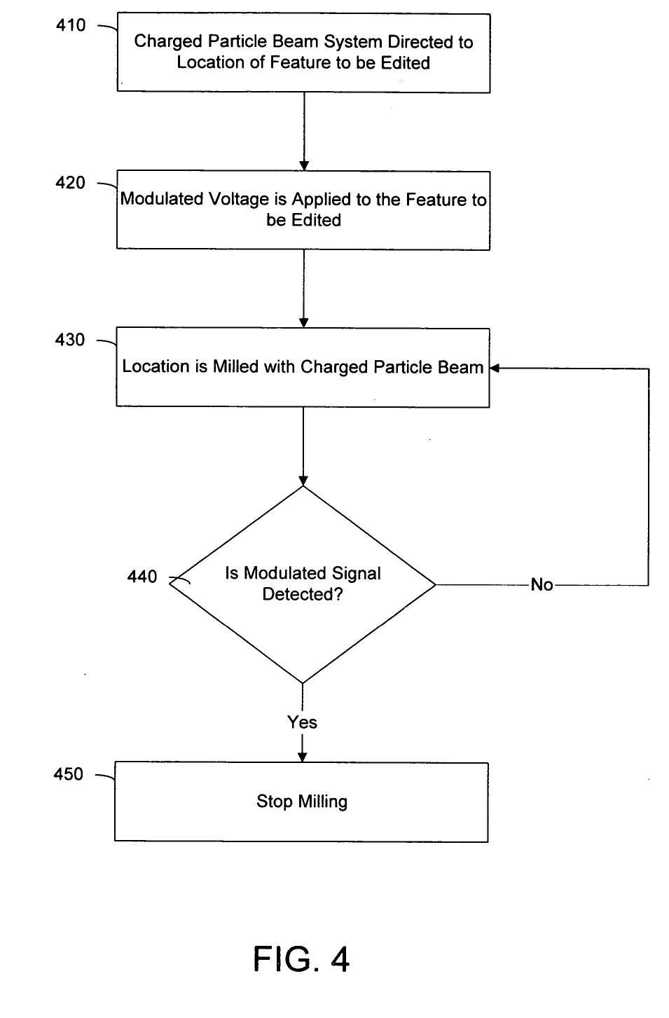

FIG. 4 is a flowchart showing the steps of this preferred embodiment of the present invention. To practice this invention, in step 410, the charged particle beam system navigates to the appropriate location of the feature to be edited. In step 420, the feature (such as a buried conductor) at which we want to detect the appropriate end point in the ion milling process has a modulated voltage applied to it. One method of applying the voltage on a packaged device is by making contact to the pin on the chip that addresses that line. Alternatively, one could avoid having to locate the correct pin by contacting all pins to the modulating voltage. A modulation containing only one frequency component (i.e., a sine wave) is the preferred waveform. The amplitude of the modulation should be the same as the voltage at which the device is designed to run. This gives maximum signal at the desired frequency without the danger of damaging the device.

The frequency of the modulation is preferably chosen to be within two constraints. First, the frequency of modulation, f, is preferably less than half the ion beam frequency, f_{c}, that is, f<0.5 f_{c}. This allows at least two samples of beam induced secondary emission signal to be captured per modulation period. The ion beam typically scans a series of dwell points in a rectangular or other geometric pattern. While the beam scans, a signal is generated by a secondary particle detector. Upon completion of a scan pattern, the beam returns the beginning of the pattern and then scans the pattern again. The time between scans is often increased to allow an etch enhancing gas to redeposit onto the surface of the work piece. Because the material being etched is relatively uniform, the current is relatively constant during the scan. The current during each scan is averaged to create one sample point. Each scan corresponds to a sample point, and the ion beam frequency f_{c} is the frequency at which the entire pattern is scanned to create one sample point.

The second constraint on the modulation frequency is designed to prevent over-etching between taking samples. The period between when the first patch of metal in the access hole becomes exposed and when substantially all of the conductor has been cleared from the bottom of the hole is designated as T_{breakthrough}. T_{breakthrough} will be determined by the etch rate and the conductor thickness. The period between modulation cycles should be less than T_{breakthrough} so that the conductive layer will not be substantially degraded before the conductor is detected. Mathematically, the modulation frequency should be greater than the inverse of T_{breakthrough}, that is, f>1/T_{breakthrough}. This allows the system to respond quickly enough to avoid over-milling. For example, typical values of f_{c}=1 kHz and T_{breakthrough}=3 sec would suggest using a frequency of modulation greater than 3 Hz and less than 500 Hz (3 Hz<f<500 Hz). Once an appropriate modulated voltage has been applied, in step 430, the charged particle beam is addressed to the area of insulator to be milled away to expose the metal line.

A time constant for post-demodulation filtering of 100-300 milliseconds is preferred. As the largest period of the modulating signal should be less than this time, a narrower acceptable frequency range of 10 Hz<f<500 Hz is preferred for the modulating signal. To avoid AC line voltage frequencies getting onto the signal, one could further lower the range to 10 Hz<f<60 Hz. A preferred frequency is about 20 Hz. The frequency detection is in the absolute, not the differential, mode. The phase difference between the modulating signal and the detector signal can be determined beforehand by maximizing the signal on a test metal line.

Step 440 comprises determining whether the modulated signal has been detected. To get a narrower frequency acceptance band in the signal detection, a lock-in amplifier can be employed. If the modulated signal has not been detected, the process loops back to step 430 and the milling continues. When the modulated signal is detected, the process continues to step 450 and milling is stopped. Skilled persons will recognize that the applied modulating voltage would affect the total stage current in the same manner as it would affect the secondary particle current. In any of the embodiments above, either stage current or secondary particle, such as secondary electron, current can be used as the work piece output signal

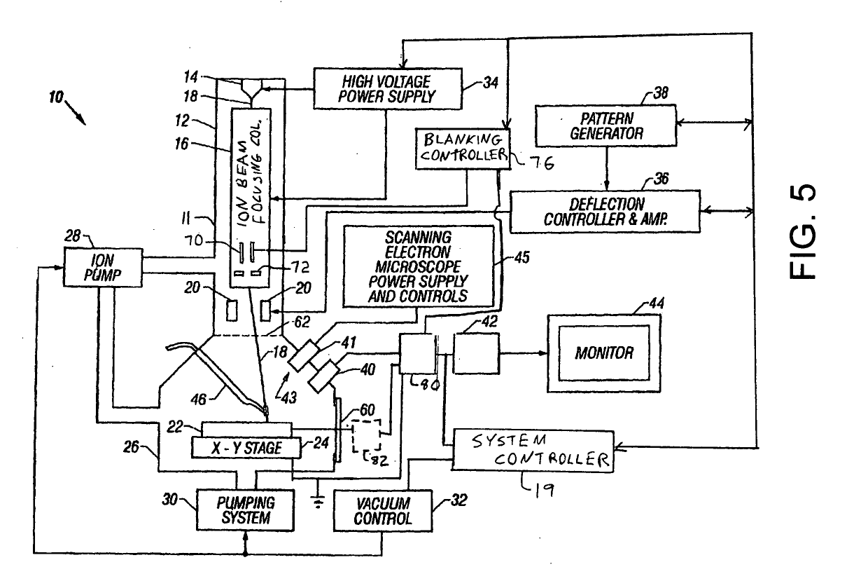

FIG. 5 shows a typical charged particle beam system, focused ion beam system 10, suitable for practicing the present invention. Focused ion beam system 10 includes an evacuated envelope 11 having an upper neck portion 12 within which are located a liquid metal ion source 14 and a focusing column 16 including extractor electrodes and an electrostatic optical system. Other types of sources, such as multicusp or other plasma sources, and other optical columns, such as shaped beam columns, could also be used. The invention can also be used with an electron beam system.

An ion beam 18 passes from source 14 through column 16 and between electrostatic deflection means schematically indicated at 20 toward sample 22, which comprises, for example, a semiconductor device positioned on movable X-Y stage 24 within lower chamber 26. A system controller 19 controls the operations of the various parts of system 10. An ion pump 28 is employed for evacuating neck portion 12. The chamber 26 is evacuated with turbomolecular and mechanical pumping system 30 under the control of vacuum controller 32. The vacuum system provides within chamber 26 a vacuum of between approximately 1×10⁻⁷ Torr and 5×10⁻⁴ Torr. If an etch assisting, an etch retarding gas, or a deposition precursor gas is used, the chamber background pressure may rise, typically to about 1×10⁻⁵ Torr.

High voltage power supply 34 is connected to liquid metal ion source 14 as well as to appropriate electrodes in focusing column 16 for forming an approximately 1 keV to 60 keV ion beam 18 and directing the same downwardly. Deflection controller and amplifier 36, operated in accordance with a prescribed pattern provided by pattern generator 38, is coupled to deflection plates 20 whereby beam 18 may be controlled to trace out a corresponding pattern on the upper surface of sample 22. In some systems the deflection plates are placed before the final lens, as is well known in the art. Beam blanking electrodes 70 cause beam 18 to impact onto blanking aperture 72 instead of target 22 when blanking controller 76 applies a blanking voltage to blanking electrode 70.

The source 14 typically provides a metal ion beam of gallium. The source typically is capable of being focused into a sub one-tenth micron wide beam at sample 22 for either modifying the sample 22 by ion milling, enhanced etch, material deposition, or for the purpose of imaging the sample 22. A charged particle detector 40, such as an Everhart Thomley or multi-channel plate, used for detecting secondary ion or electron emission is connected to a frequency sensitive amplifier, such as a lock-in amplifier 80, and a video circuit 42, the latter supplying drive for video monitor 44 also receiving deflection signals from controller 36. In some embodiments, lock-in amplifier 80 receives a reference signal from blanking controller 76 or stage current from stage 24. In other embodiments, a modulator 82 provides a modulating signal to target 22 and provides a reference signal to amplifier 80.

The location of charged particle multiplier 40 within chamber 26 can vary in different embodiments. For example, a charged particle multiplier 40 can be coaxial with the ion beam and include a hole for allowing the ion beam to pass. In other embodiments, secondary particles can be collected through a final lens and then diverted off axis for collection. A scanning electron microscope 41, along with its power supply and controls 45, are optionally provided with the FIB system 10.

A gas delivery system 46 extends into lower chamber 26 for introducing and directing a gaseous vapor toward sample 22. U.S. Pat. No. 5,851,413 to Casella et al. for “Gas Delivery Systems For Particle Beam Processing,” assigned to the assignee of the present invention, describes a suitable fluid delivery system 46. Another gas delivery system is described in U.S. Pat. No. 5,435,850 to Rasmussen for a “Gas Injection System,” also assigned to the assignee of the present invention.

A door 60 is opened for inserting sample 22 onto stage 24, which may be heated or cooled, and also for servicing an internal gas supply reservoir, if one is used. The door is interlocked so that it cannot be opened if the system is under vacuum. The high voltage power supply provides an appropriate acceleration voltage to electrodes in ion beam column 16 for energizing and focusing ion beam 18. When it strikes sample 22, material is sputtered, that is physically ejected, from the sample. Focused ion beam systems are commercially available, for example, from FEI Company, Hillsboro, Oregon, the assignee of the present application. The invention is not limited to being implemented in any particular type of hardware.

Although the present invention and its advantages have been described in detail, it should be understood that various changes, substitutions and alterations can be made herein without departing from the spirit and scope of the invention as defined by the appended claims. For example, although the invention was described in terms of focused ion beam milling, it could readily be applied to electron beam milling. The invention could also be applied to deposition, with the change in signal indicating that a conductive path is completed by deposition of a conductive pathway or that an insulating layer has covered the conductive layer.

Some embodiments can also be used in conjunction with other methods, for example, voltage contrast methods. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of determining an end point to a charged particle beam process, comprising:
directing a charged particle beam in a pattern onto a work piece, the pattern being repeated periodically and the beam being blanked between repetitions of the pattern, the repeated blanking defining a blanking frequency;
detecting an output signal caused by the impact of the particles in the charged particle beam onto the work piece, the output signal including a secondary particle signal or a stage current signal:
providing the output signal to a circuit adjusted to improve the signal-to-noise ratio of a signal at the blanking frequency;
monitoring the output of the circuit to detect a change in the material at the impact point of the charged particle beam.

2. The method of claim 1 in which providing the output signal to a circuit adjusted to improve the signal-to-noise ratio of a signal at the blanking frequency includes providing the output signal to a lock-in amplifier.

3. The method of claim 1 in which providing the output signal to a circuit adjusted to improve the signal-to-noise ratio of a signal at the blanking frequency includes providing a reference signal having a frequency that is substantially the same as of the blanking frequency.

4. The method of claim 3 in which providing a reference signal having a frequency that is substantially the same as of the blanking frequency includes adjusting the phase of the reference signal to maximize the amplifier output.

5. The method of claim 1 in which directing a charged particle beam to the work piece includes directing a focused ion beam to an insulating material covering a conductor and in which monitoring output of the frequency sensitive amplifier includes monitoring the detector signal to detect a change in the amplifier output indicating that the insulating material has been substantially removed and the ion beam is impinging upon the conductor.

6. The method of claim 1 in which directing a charged particle beam to the work piece includes directing an electron beam to an insulating material covering a conductor and in which monitoring output of the frequency sensitive amplifier includes monitoring the detector signal to detect a change in the amplifier output indicating that the insulating material has been substantially removed and the electron beam is impinging upon the conductor.

7. The method of claim 1 in which the blanking frequency is between about 100 Hz and about 500 Hz.

8. The method of claim 1 detecting an output signal caused by the impact of the particles in the charged particle beam onto the work piece includes detecting a stage current signal.

9. The method of claim 1 detecting an output signal caused by the impact of the particles in the charged panicle beam onto the work piece includes detecting a secondary electron signal.

10. The method of claim 1 in which monitoring the output of the circuit to detect a change in the material at the impact point of the charged particle beam includes generating a detector signal from a current generated by the charged particle includes detecting a current of secondary charged particles ejected from the work piece by the interaction of the charged particle beam with the surface or detecting a stage current.

11. The method of claim 6 in which directing a charged particle beam to the work piece includes directing a focused ion beam or an electron beam to the work piece.

12. The method of claim 6 in which electronically monitoring the detector signal includes periodically sampling secondary charged particle current.

13. The method of claim 1 in which providing the output signal includes providing an Output signal that is not provided by way of an electrical conductor attached to the work piece.

14. A method of altering an element of an integrated circuit by using a charged particle beam, comprising:
charged particle beam milling through one or more layers of material to expose the circuit element;
detecting an output signal caused by the impact of the focused ion beam, the output signal including a secondary charged particle signal or a stage current;
providing the output signal to a circuit adjusted to improve the signal-to-noise ratio of a signal at a blanking frequency:
ceasing to mill when the output of the circuit adjusted to improve the signal-to-noise ratio of a signal at the blanking frequency changes more than a predetermined amount, the change indicating a change of material impacted by the charged particle beam.

15. The method of claim 14 in which ceasing to mill when the output of the circuit adjusted to improve the signal-to-noise ratio of a signal at the blanking frequency changes more than a predetermined amount includes ceasing to mill when the element is uncovered and before the element is severed.

16. The method of claim 14 further comprising milling through the exposed element and in which ceasing to mill when the output of the circuit adjusted to improve the signal-to-noise ratio of a signal at the blanking frequency changes more than a predetermined amount includes ceasing to mill when the exposed element is severed.

17. The method of claim 14 in which a frequency sensitive circuit is a lock-in amplifier, or a band pass filter.

18. The method of claim 14 in which the output signal is determined from a current of secondary electrons ejected from the work piece.

19. The method of claim 14 in which the blanking frequency is between about 100 Hz and about 500 Hz.

20. A method of determining a change in a work piece undergoing charged particle beam processing, comprising:
applying a modulating signal to a conductor within the work piece being processed;
directing a charged particle beam to the work piece;
generating a detector signal from a current generated by the charged particle beam, the current correlated to the material being processed by the charged particle beam;
electronically monitoring the detector signal to detect an influence from the modulating signal, a change in the influence of the modulating signal indicating that the material being processed by the material particle beam has changed.

21. The method of claim 20 in which applying a modulating signal includes applying a modulating signal having a frequency component and in which monitoring the detector signal includes processing the signal using a circuit sensitive to the frequency component to enhance detection of the frequency component in the detector signal.

22. The method of claim 21 in which processing the signal using a circuit sensitive to the frequency component includes processing the signal using a lock-in amplifier.

23. The method of claim 21 in which processing the signal using a circuit sensitive to the frequency component includes processing the signal using a band pass filter.

24. The method of claim 20 in which processing of a conductor on the work piece is characterized by a breakthrough period and in which applying a modulating signal includes applying a modulating signal having a frequency greater than the inverse of the breakthrough period and less than one half of the ion beam frequency.

25. The method of claim 20 in which applying a modulating signal includes applying a modulating signal having a frequency of between 3 Hz and 500 Hz.

26. The method of claim 20 in which applying a modulating signal includes applying a modulating signal having a frequency of between 10 Hz and 60 Hz.

27. The method of claim 20 in which generating a detector signal from a current generated by the charged particle includes detecting a current of secondary charged particles ejected from the work piece by the interaction of the charged particle beam with the surface or detecting a stage current.

28. The method of claim 20 in which directing a charged particle beam to the work piece includes directing a focused ion beam or an electron beam to the work piece.

29. The method of claim 20 in which electronically monitoring the detector signal includes periodically sampling secondary changed particle current.
